(19) United States
(12) Patent Application Publication
(10) Pub. No.: US 2005/0252720 A1
(43) Pub. Date: Nov. 17, 2005

(54) Vehicle hitch receiver mounted portable stairs

(76) Inventors: Ivan Chant, Devine, TX (US); James Ivan Chant, Mead, WA (US)

Correspondence Address: Richard C. Litman;LITMAN LAW OFFICES, LTD., P.O. Box 15035, Arlington, VA, 22215, US

(21) Appl. No.: 10/842,434

(22) Filed: May 11, 2004

(51) Int. Cl. E06C 5/00

(52) U.S. Cl. 182/127

(57) ABSTRACT

A vehicle hitch receiver mounted portable stairs fits a conventional hitch receiver of a pickup truck. An extended tongue fits the hitch receiver, secured by a hitch pin. The tongue is of a length that a pickup tailgate may be lowered to a horizontal position while the stairs attachment is mounted. The support has a rearward-sloping upright attached to the rear end of the tongue and ending in a flat horizontal plate. The plate supports a horizontal cross beam at its center, the cross beam supporting end beams to which the stairs is attached. The stairs assembly includes a series of horizontal stair steps supported at their ends by support rails extending upward at a rearward angle from the supporting end beams of the support assembly. An upper platform is mounted horizontally at the top of the stairs. A handrail may be added to the stairs assembly.

### BACKGROUND OF THE INVENTION

1. Field of the Invention

The present invention relates to portable stairs or ladders. More particularly, the present invention relates to vehicle-mounted portable stairs or ladders.

2. Description of the Related Art

The use of trailer-mounted ladders and platforms is well known. Also the mounting of ladders on a vehicle such as a truck is known, a fire truck hook and ladder vehicle being an example.

In some states in the U.S. the use of feeders for deer is legal and practiced. Such feeders release feed corn, attracting and keeping deer in the immediate area during hunting season. Also, the feeders are often used to sustain deer during other parts of the year, providing other types of feed. Such feeders are tank-like structures, such as a barrel, erected on legs and which has a corn distributor locate at the lower center of the bottom wall of the feeder. Such feeders typically have a ladder for scaling the height of the top of the feeder for periodically replenishing the corn as it is fed. The corn is typically provided in 50-pound bags and substantial strength and dexterity is required to supply corn to the feeder, which requires dumping the contents of the bags over the upper wall of the feeder tank. The filling of a number of feeders spaced through the hunting area is a time consuming and arduous task. It would be desirable to provide a portable stairs for use with a vehicle which allows for ease in climbing and dumping the bags of corn into the feeders. It would also be desirable to provide such a stairs which easily attaches and detaches from the vehicle and, in the case of a pickup truck, allows bags of feed corn to be carried from the bed, over the opened tail gate, and directly up the stairs. A stairway is preferable to a ladder since climbing with a load is much easier. It would be convenient if a hitch receiver as is commonly used on pickup trucks could support the stairs.

U.S. Patent Application No. 2002/0134620 A1, published Sep. 26, 2002, for Meyer, describes a mobile, elevated viewing platform attachment having a ladder which is supported by a hitch receiver. The platform also employs leveling legs for added support.

U.S. Pat. No. 2,586,531, issued Feb. 19, 1952, to Gordon, describes a truck-mounted ladder assembly.

U.S. Pat. No. 4,408,680, issued Oct. 11, 1983, to Ross, describes a ladder support assembly for use with a vehicle wherein the lowermost portion of a ladder is pivotally and detachably connected to the vehicle bumper. Cables are attached between the upper portion of the ladder and the vehicle to hold the ladder in a position leaning away from the vehicle.

U.S. Pat. No. 4,614,252, issued Sep. 30, 1986, to Tarner, describes a portable observation structure which is removably attachable to a wheeled vehicle and features two pairs of upright legs in the form of a ladder arrangement.

None of the above inventions and patents, taken either singly or in combination, is seen to describe the instant invention as claimed. Thus a vehicle hitch receiver mounted portable stairs solving the aforementioned problems is desired.

### SUMMARY OF THE INVENTION

The vehicle hitch receiver mounted portable stairs of the present invention provides portable stairs having a support assembly which fits into a conventional hitch receiver as mounted below the rear bumper of a vehicle such as a pickup truck. The support assembly has an extended tongue, fitting within the hitch receiver and secured by a hitch pin. The tongue is of sufficient length that a tailgate of a pickup truck may be lowered to a horizontal position while the stairs attachment is mounted in place on the truck. The support has a rearward-sloping upright attached to the rear end of the tongue at and angle of about 120 degrees and a brace extends between the central portions of the tongue and the upright. A flat plate is mounted on the upper end of the upright at such an angle as to be horizontal when mounted on the vehicle. The plate supports a horizontal cross beam at its center, the cross beam supporting end beams to which the stairs is attached.

The stairs assembly includes a series of horizontal stair steps supported at their ends by support rails extending upward at a rearward angle from the supporting end beams of the support assembly. An upper platform is mounted at the top of the stairs and is made up of a stair step similar to the lower steps and a rearward extension secured by end beams. The upper ends of the support rails are attached to the end beams at an angle such that the upper platform is horizontal. A handrail may be installed along one or both sides of the stairs for added security during climbing.

The portable, hitch-mounted stairs of the present invention is particularly useful for filling elevated grain feeders in the field such as those used for dispensing grain to attract deer. The grain is typically corn in 50-pound bags which must be carried from the pickup bed up to the top of the feeder and manually dumped into the feeder tank. The provision for the lowered tailgate makes travel from the truck bed to the stairs easy and convenient. The stairs is much easier and safer to ascend while carrying the bag of corn than the typical ladder. Since no setup time is required, the portable stairs of the present invention may be efficiently moved from feeder to feeder in a given area, allowing for safe and quick filling of a number of feeders.

It is an aspect of the invention that improved elements and arrangements thereof are provided for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, rear perspective view of a vehicle hitch receiver mounted portable stairs according to the present invention.

FIG. 2 is an environmental front perspective view of the portable stairs of FIG. 1.

FIG. 3 is an environmental, side elevation view of the portable stairs of FIG. 1.

FIG. 4 is an exploded view of the upper portion of the portable stairs of FIG. 1.

FIG. 5 is an exploded view of the lower portion of the portable stairs of FIG. 1.

Similar reference characters denote corresponding features consistently throughout the attached drawings.

### DETAILED DESCRIPTION OF THE PREFERRED EMBODIMENT

The present invention is a vehicle hitch receiver mounted portable stairs which provides portable stairs having a support assembly which fits into a conventional hitch receiver as mounted below the rear bumper of a vehicle such as a pickup truck.

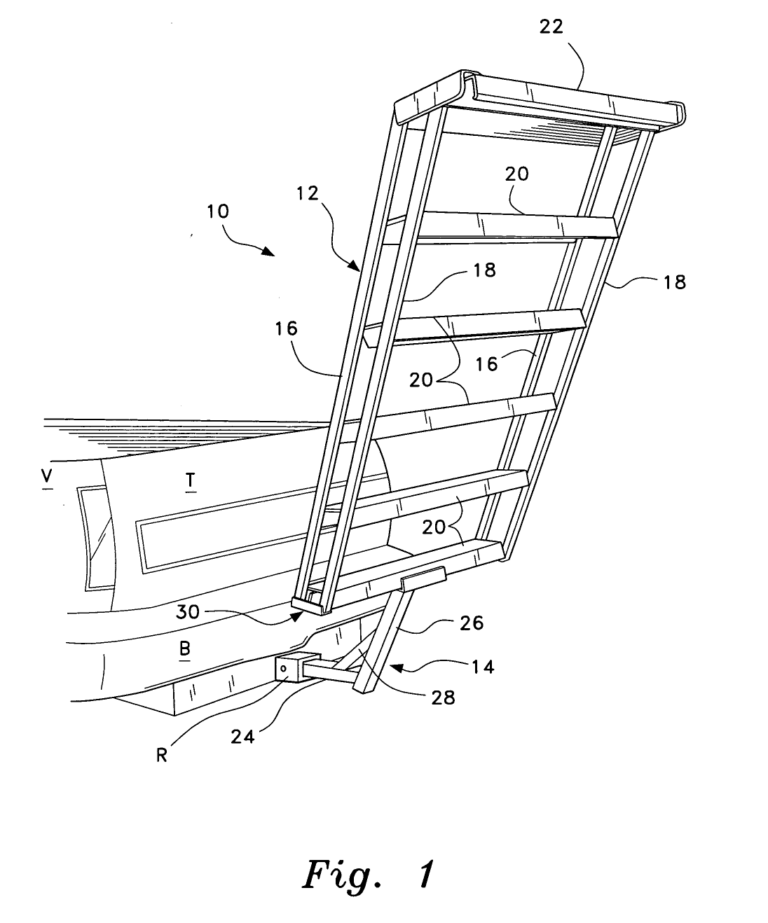

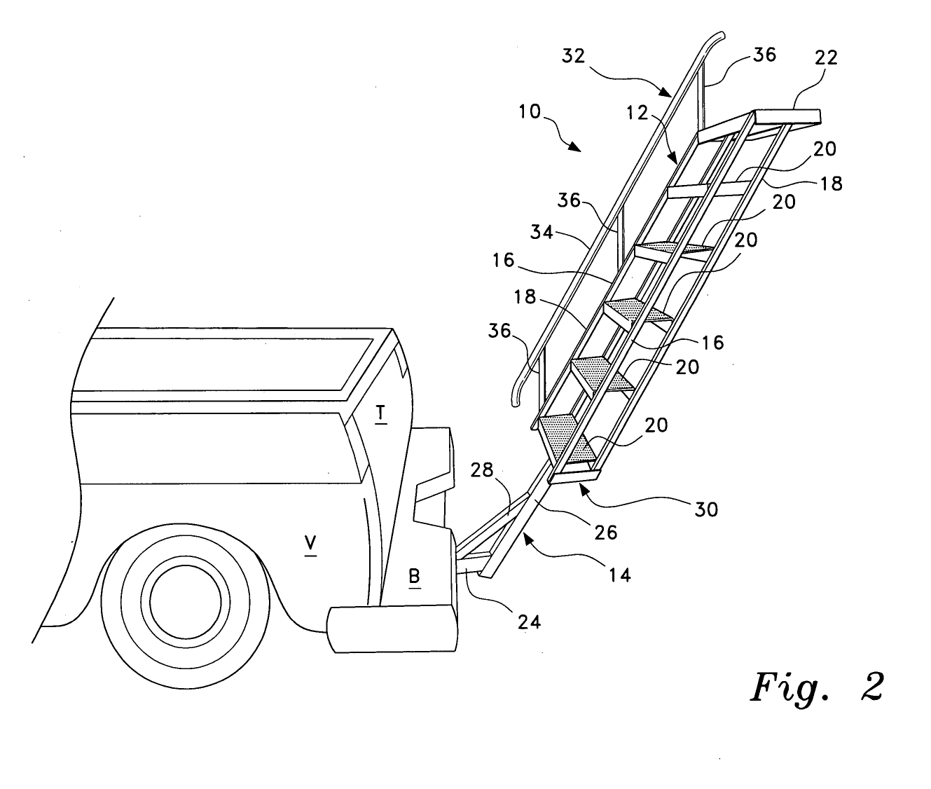

Referring to FIGS. 1 and 2, there is shown an environmental rear perspective view and environmental front perspective view, respectively, of the hitch receiver mounted portable stairs of the present invention referred to by reference number 10. Portable stairs 10 includes a stairs assembly 12 and a stairs support assembly 14 for supporting stairs assembly 12. Stairs assembly 12 includes pairs of stair front step support rails 16 and stair rear step support rails 18, supporting a plurality of steps 20 therebetween. An upper platform 22 is located at the upper end of stairs assembly 12.

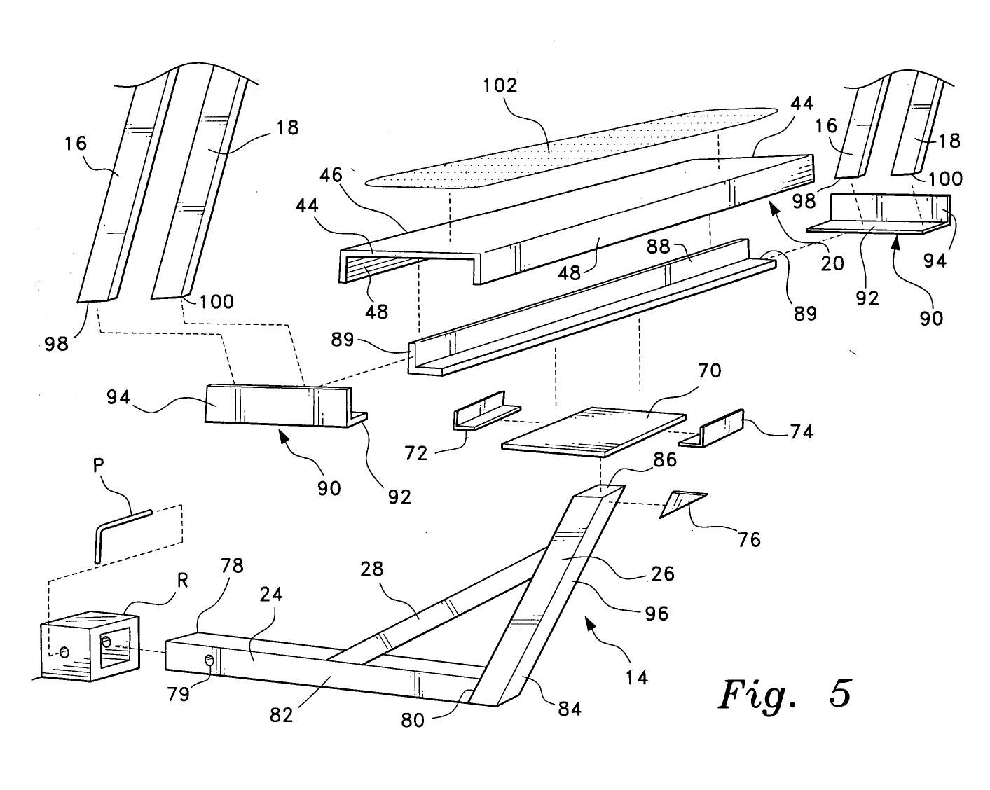

Stairs support assembly 14 includes a stairs support tongue 24 and a support upright 26 attached to tongue 24, preferably extending upwardly and outwardly at an obtuse angle of about 120 degrees. A brace 28 is attached between support tongue 24 and support upright 26 for added rigidity. A lower stair and rail support assembly 30 (see FIG. 5) is attached to and is supported by support upright 26. As shown, portable stairs 10 is mounted to vehicle V such as a pickup truck having rear bumper B and tailgate T. The tongue 24 of stairs support assembly 14 is shown inserted into the hitch receiver R such that portable stairs 10 may be moved between locations for use and is ready for climbing at a given location without further adjustment or preparation. As seen in FIG. 2, a handrail 32 may optionally be incorporated into the portable stairs 10, handrail 32 having a rail 34 supported by rail support uprights 36 attached to stair step support rails 16 so as to extend parallel therewith for assisting a climbing worker. Handrails 32 may be installed along both sides of stairs 10 as desired.

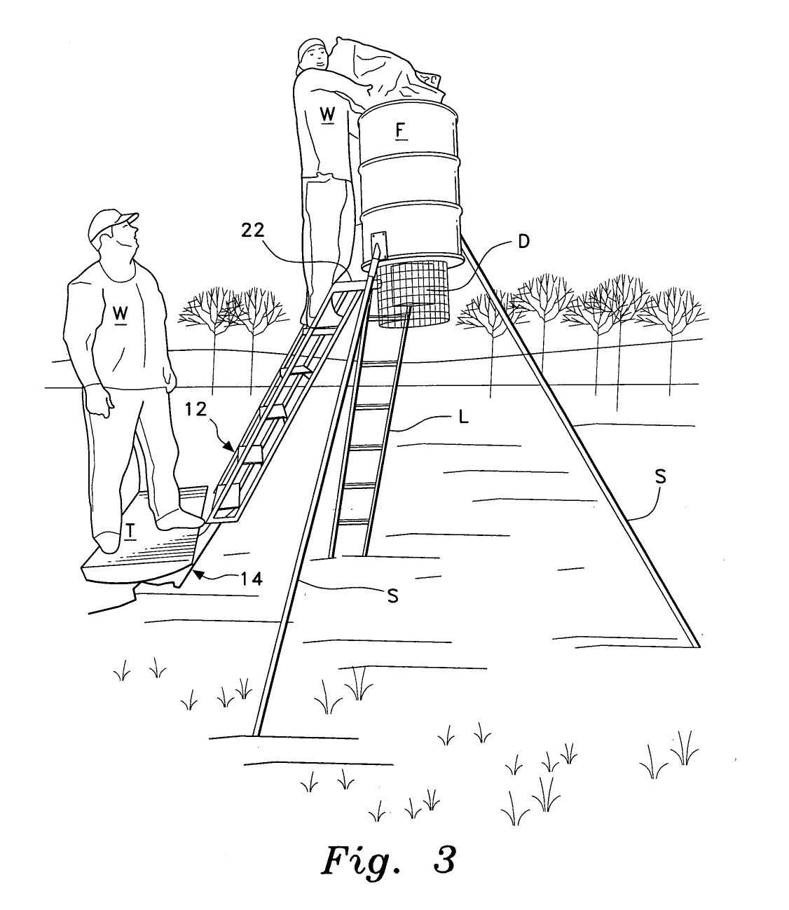

Referring to FIG. 3, there is shown an environmental side perspective view of the portable stairs 10 of the present invention as mounted on a pickup truck having the tailgate T in a horizontal position. The tongue 24 of support assembly 14 (see FIG. 2) is of sufficient length to allow the tailgate T to be lowered to the opened, horizontal position. This greatly facilitates the use of the stairs assembly 12 by workers W as they travel between the truck bed and the stairs assembly. As shown, an elevated feeder barrel F having a grain distributor D is supported on feeder support legs S and ladder L. Workers W are moving bags of grain, typically 50 pound bags, from the bed of the pickup to be dumped into the open top of feeder barrel F by walking across tailgate T and climbing up stairs assembly 12. Upper platform 22 is used for placing the bag of grain before the worker W completes climbing the stairs. It is clear that the inventive portable stairs in conjunction with the pickup allows for easier and safer replenishment of grain by a worker W than by climbing the ladder L.

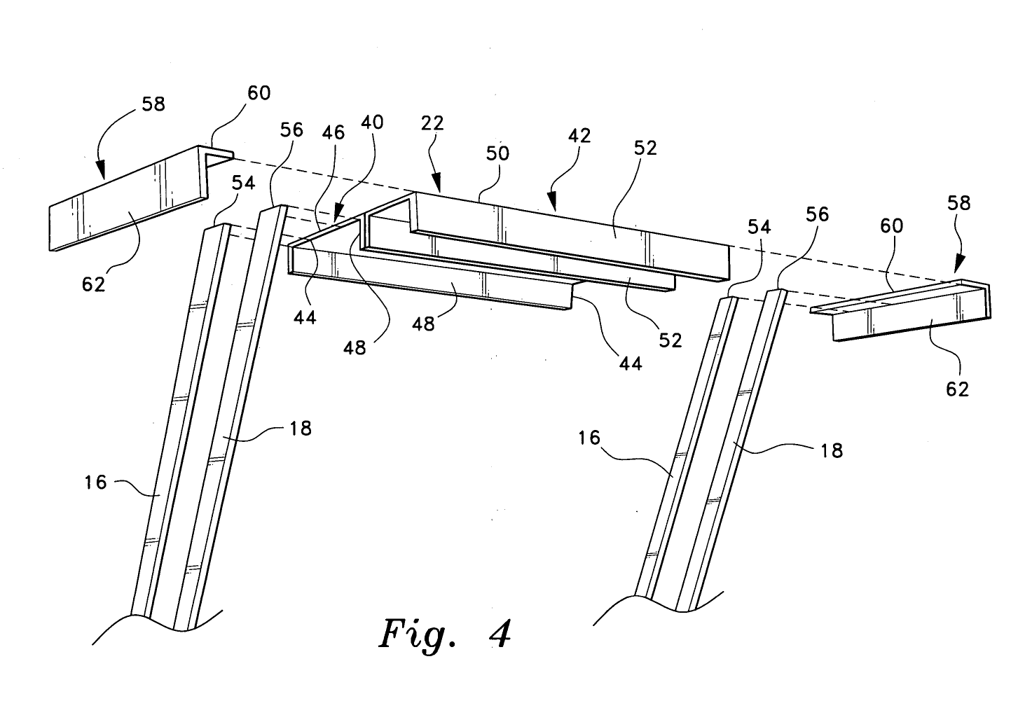

Referring to FIG. 4, there is shown an exploded view of the upper portion of the stairs assembly of the present invention wherein upper platform 22 is shown broken away from pairs of step support rails 16 and 18. Upper platform 22 is made up of a top step 40 which is identical in configuration to steps 20. Step 40 has an extension 42 similar in configuration to that of step 40, but is shown as shallower, although the extension 42 may be of any desired size. Step 40 is in a generally inverted channel shape having opposed ends 44, a tread 46, and depending stiffening portions 48 along the front and rear of tread 46.

Upper step extension 42 has an upper surface or tread 50 and is of the same length as upper stair 40, having its opposed ends coinciding therewith. Upper step extension 42 also has a generally inverted channel shape having depending platform extension channel sides 52. Step opposed ends 44 are attached to respective front step support rails 16 and stair rear step support rails 18 proximate their respective upper ends 54 and 56 as by welding. Upper end angle beams 58 each have a horizontal flange 60 and a vertically depending flange 62. When assembled, upper flanges 60 extend over support rail upper ends 54 and 56, respectively and are attached over step tread 46 proximate respective opposed ends 44 as by welding.

Upper end angle beams 58 extend forward from upper step 40, and step extension 42 is attached thereto at upper surface 50 proximate its opposed ends as by welding so as to be in line with upper step 40 and preferably immediately adjacent thereto, providing a continuous upper surface for upper platform 22. The front and rear pairs of step support rails 16 and 18 are attached to the depending flanges 62 of upper end angle beams 58, proximate their respective upper ends 54 and 56, the upper ends 54 and 56 bearing against horizontal flanges 60. All attachments may be accomplished by welding or the like.

Referring to FIG. 5, there is shown an exploded view of the stairs support assembly 14 and the lower portion of the stairs assembly 12 (see FIG. 1). Stairs support tongue 24 has a forward insert end 78 and a hitch pin receiving bore 79 spaced therefrom for insertion into hitch receiver R and securing by hitch pin P in a known manner. Stairs support tongue 24 also has a rear end 80 and a central portion 82. Stairs support upright 26 has a lower end portion 84, an upper end 86, and a central portion 96, the lower portion 84 being attached at an obtuse angle to tongue rear end 80 so as to extend upwardly and rearwardly therefrom. Support brace 28 extends between tongue central portion 82 and upright central portion 96 so as to provide rigidity to the support assembly 14.

Support plate 70 is centrally mounted to support upright upper end 86 at an angle such as to be horizontal and extend parallel with tongue 82 when the vehicle V is on level ground (see FIG. 1). A gusset 76 is attached between stairs support upright 26 proximate its upper end 86 and the lower rear surface of support plate 70 to reinforce the connection between support upright 26 and support plate 70. Front angle beam 72 and rear angle beam 74 are attached to and extend along the respective front and rear edges of support plate 74 for attachment to the respective front and rear step channel depending stiffening portions 48. Cross beam 88 is centrally attached to support plate 70 and extends equidistant therefrom perpendicular to stair support tongue 24.

Lower support angle beams 90 are centrally attached perpendicular to respective outer ends 89 of cross beam 88 such the ends 89 bear against upward extending flange 94 and rest on horizontal flange 92 of lower support angle beams 90. Front step support rails 16 have lower ends 98 and rear step support rails 18 have lower ends 100. When assembled, front step support rails 16 and rear step support rails 18 rest on respective horizontal flanges 92 of lower support angle beams 90 at locations on opposite sides of and spaced from cross beam outer ends 89 of cross beam 88 and are connected along their sides to corresponding upward extending flanges 94 at a desired angle.

Lower step 20 is attached at opposed ends 44 to respective pairs of front step support rails 16 and rear step support rails 18. Lower step 20 is preferably positioned such that its channel depending stiffening portions 48 reach to support plate 70. The upper portions of front angle beam 72 and rear angle beam 74 are preferably attached to respective the step 20 front and rear stiffening portions 48 such as by welding for improved anchoring of the stairs assembly 12 to stairs support assembly 14.

Steps 20 have their treads 46 covered with a conventional non-skid material 102 such as a plastic sheet having grit or other non-skid material incorporated on the upper surface thereon.

The inventive portable stairs is preferably about 5′9″ in height between the tongue and the upper platform. The angle of the stairs to the vertical may vary but is preferably about 30 degrees. The tongue hitch pin receiver bore is preferably about 2½″ from the front insert end of the tongue and the overall length of the tongue is about 14″, the stairs support upright being about 22½″ in overall length. The brace is about 15¼″ in length and extends from a point about 8 inches from the tongue insert end to meet with the stairs support upright. The support plate is about 6″ square and made of ¼″ steel plate. The gusset is ¼″ steel plate.

The tongue and the support upright are cut from 2″ square tubing, having 3/16″ thick sidewalls. The brace is cut from 1½″ square tubing having ⅛″ thick sidewalls. The step support rails are cut from 1″ square tubing having ⅛″ sidewalls. All tubing is structural tubing. The steps are about 2 feet wide with a depth of 6″ and are preferably cut from 11 gauge (⅛″) purlins (metal building roofing and wall supports), the sidewalls being 2″ in height. The extension of the upper platform is cut from 4″ purlins.

The cross beam of the stairs support is cut from 2″×2″×⅛″ angle iron to a length of 26″. The upper and lower end angle beams are cut from 1¼″×1¼″ by ⅛″ angle iron, the upper end beams being cut at 10″ and the lower end beams being cut at 6″ in length. The front angle beam and the rear angle beam are both cut from 1¼″×1¼″×⅛″ angle iron at 6″ in length.

The inventive portable stairs as described above is light in weight, weighing about 73 pounds. The assembly of the portable stairs is preferably carried out by welding, however, other methods of assembly are contemplated by the present invention. Although structural steel is the preferred material, and appropriate material may be used in the construction of the portable stairs of the present invention

It is to be understood that the present invention is not limited to the embodiment described above, but encompasses any and all embodiments within the scope of the following claims.

1. A vehicle hitch receiver mounted portable stairs, comprising:
a stairs support assembly having a horizontally disposed tongue for removable mounting within a horizontal vehicle hitch receiver;
a stairs assembly having a plurality of steps including a lower step and an upper step, said stairs assembly being supported by said stairs support assembly;
said stairs assembly extending upward from said stairs support assembly.

2. The portable stairs of claim 1, said vehicle hitch receiver being centrally mounted at the lower rear of said vehicle and wherein said stairs assembly extends upwardly and rearwardly from said vehicle and said vehicle hitch receiver.

3. The portable stairs of claim 1, said stairs support assembly further comprising an upper platform formed by said upper step and a step extension, said step extension extending rearwardly from said upper step.

4. The portable stairs of claim 1, said tongue having a forward end, a rear end, and a central portion, said stairs support assembly having a support upright having a lower end portion attached to said rear end of said tongue and an upper end, said support upright extending upwardly and rearwardly from said rear end of said tongue, said support upright having a horizontally disposed support plate centrally connected at said upper end thereof.

5. The portable stairs of claim 4, said stairs support assembly further comprising a horizontally disposed cross beam having outer ends and centrally attached to said support plate, said cross beam extending perpendicular to said tongue.

6. The portable stairs of claim 5, said stairs support assembly further comprising horizontally disposed lower support beams centrally attached to said respective outer ends of said cross beam and perpendicular thereto.

7. The portable stairs of claim 6, said stairs support having a reinforcing gusset extending rearwardly between the upper portion of said stairs support upright and said support plate, said stairs support having a brace extending between said central portion of said tongue and the upper end portion of said stairs support upright.

8. The portable stairs of claim 2, said stairs assembly comprising at least one stairs support rail attached to each of opposed ends of said plurality of steps and attached to and extending upwardly and rearwardly from said stairs support assembly.

9. The portable stairs of claim 8, said stairs assembly having a front support rail and a rear support rail at each end of said plurality of steps.

10. The portable stairs of claim 9, said stairs assembly having an upper platform comprising said upper step and a step extension extending rearward from said upper step.

11. The portable stairs of claim 10, said upper platform further comprising upper end beams located at the respective ends of said upper step and said step extension, said upper step and said step extension being connected by said upper end beams.

12. The portable stairs of claim 11, said upper end beams of said upper platform being connected to the upper ends of said respective front support rail and said rear support rails respectively.

13. The portable stairs of claim 12, said upper end beams being angle beams each having an upper horizontal flange and a depending flange, said upper horizontal flange connecting said upper step and said step extension and receiving said respective upper ends of said front and rear support rails, said depending flange being connected along said upper end portions of said front and rear support rails.

14. The portable stairs of claim 8, further comprising at least one stair handrail having a plurality of vertical rail support uprights attached along and extending upward from said stair step support rail and a rail attached to said rail support uprights and extending generally parallel to said stair step support rail.

15. The portable stairs of claim 1, said steps being in the general form of an inverted channel structure having an upper, horizontally disposed tread portion and front and rear depending front and rear stiffening portions.

16. The portable stairs of claim 8, each said stairs support beam being an angle beam having a lower, horizontal flange and an upward-extending flange, said stairs assembly having respective front and rear step support rails, said step support rails being supported at their respective lower ends by said horizontal flanges of said stairs support beams and attached to said upward-extending flanges along the lower end portions, respectively.

17. A vehicle hitch receiver mounted portable stairs, comprising:
a stairs support assembly having a horizontally disposed tongue for removable mounting within a horizontal vehicle hitch receiver;
a stairs assembly having a plurality of steps including a lower step and an upper step, said stairs assembly being supported by said stairs support assembly;
said stairs assembly extending upward from said stairs support assembly;
said vehicle hitch receiver being centrally mounted at the lower rear of said vehicle and wherein said stairs assembly extends upwardly and rearwardly from said vehicle and said vehicle hitch receiver;
said stairs support assembly further comprising an upper platform formed by said upper step and a step extension, said step extension extending rearwardly from said upper step;
said tongue having a forward end, a rear end, and a central portion, said stairs support assembly having a support upright having a lower end portion attached to said rear end of said tongue and an upper end, said support upright extending upwardly and rearwardly from said rear end of said tongue, said support upright having a horizontally disposed support plate centrally connected at said upper end thereof;
said stairs support assembly further comprising a horizontally disposed cross beam having outer ends and centrally attached to said support plate, said cross beam extending perpendicular to said tongue;
said stairs support assembly further comprising horizontally disposed lower support beams centrally attached to said respective outer ends of said cross beam and perpendicular thereto; and
said stairs assembly comprising at least one stairs support rail attached to each of opposed ends of said plurality of steps and attached to and extending upwardly and rearwardly from said stairs support assembly.

18. The portable stairs of claim 17, said stairs assembly having a front support rail and a rear support rail at each end of said plurality of steps.

19. The portable stairs of claim 18, said stairs assembly having an upper platform comprising said upper step and a step extension extending rearward from said upper step.

20. The portable stairs of claim 19, said upper platform further comprising upper end beams located at the respective ends of said upper step and said step extension, said upper step and said step extension being connected by said upper end beams.
